(19) United States
(12) Patent Application Publication
(10) Pub. No.: US 2024/0405710 A1
(43) Pub. Date: Dec. 5, 2024

(54) POWER CONVERTER, MOTOR DRIVE APPARATUS, AND REFRIGERATION CYCLE APPLIED APPARATUS

(71) Applicant: Mitsubishi Electric Corporation, Tokyo (JP)

(72) Inventors: Shinya TOYODOME, Tokyo (JP); Kazunori HATAKEYAMA, Tokyo (JP); Shoei TSUTSUMI, Tokyo (JP)

(21) Appl. No.: 18/698,734

(22) PCT Filed: Dec. 8, 2021
(86) PCT No.: PCT/JP2021/045178

§ 371 Date: Apr. 4, 2024

(51) Int. Cl. H02P 27/08; H02P 23/04

(52) U.S. Cl. CPC H02P 27/08; H02P 23/04

(57) ABSTRACT

A power converter includes a converter that rectifies a power supply voltage applied from an alternating current power supply, a capacitor connected to an output end of the converter, an inverter connected across the capacitor, and a controller that controls an operation of the inverter. The controller performs first control of reducing vibration of a compressor and performs second control of reducing a ripple component of a capacitor output current that is output from the capacitor to the inverter. The second control is control for causing a loss in a motor.

### CROSS-REFERENCE TO RELATED APPLICATION

This application is a U.S. National Stage Application of International Application No. PCT/JP2021/045178 filed on Dec. 8, 2021, the contents of which are incorporated herein by reference.

### TECHNICAL FIELD

The present disclosure relates to a power converter that supplies alternating current power to a motor that drives a load, a motor drive apparatus, and a refrigeration cycle applied apparatus.

### BACKGROUND

A power converter includes a converter that rectifies a power supply voltage applied from an alternating current power supply, a capacitor connected to an output end of the converter, and an inverter that converts a direct current voltage output from the capacitor into an alternating current voltage and applies the alternating current voltage to a motor.

Patent Literature 1 below discloses a technique of preventing an increase in vibration by properly compensating for torque ripple, which is a ripple component of load torque, depending on a state of a motor that drives a compressor.

### PATENT LITERATURE

Patent Literature 1: Japanese Patent Application Laid-open No. 2016-082637

In an air conditioner which is one of products applying a refrigeration cycle applied apparatus, in order to prevent a failure due to harmonic components contained in a power supply current, a regulation on harmonics of the power supply current is defined. For example, in Japan, a Japanese Industrial Standard (JIS) defines a standard value that is a limit value for the harmonics of the power supply current.

However, the technique described in Patent Literature 1 does not take into account the harmonics of the power supply current. For this reason, when the technique of Patent Literature 1 is used to generate a compensation component for the torque ripple of the motor at an asynchronous frequency with respect to a power supply frequency, the power supply current has an imbalance between its positive and negative polarities, which results in a problem that the harmonic components of the power supply current are increased.

### SUMMARY

The present disclosure has been made in view of the above, and an object thereof is to provide a power converter capable of preventing an increase in harmonic components of a power supply current while compensating for torque ripple of a motor.

In order to solve the above problem and achieve the object, a power converter according to the present disclosure is a power converter that supplies alternating current power to a motor that drives a load. The power converter includes a converter that rectifies a power supply voltage applied from an alternating current power supply, and a capacitor connected to an output end of the converter. The power converter further includes an inverter connected across the capacitor, and a controller that controls an operation of the inverter. The controller performs first control of reducing vibration of the load and performs second control of reducing a ripple component of a capacitor output current that is output from the capacitor to the inverter. The second control is control for causing a loss in the motor.

The power converter according to the present disclosure has an effect of being able to prevent an increase in the harmonic components of the power supply current while compensating for the torque ripple of the motor.

### BRIEF DESCRIPTION OF DRAWINGS

FIG. 1 is a diagram illustrating an example of a configuration of a power converter according to a first embodiment.

FIG. 2 is a diagram illustrating an example of a configuration of an inverter included in the power converter according to the first embodiment.

FIG. 3 is a graph illustrating a state of operation without vibration reduction control of a motor drive apparatus according to the first embodiment.

FIG. 4 is a graph illustrating a state of operation with vibration reduction control of the motor drive apparatus according to the first embodiment.

FIG. 5 is a block diagram illustrating an example of a configuration of a controller included in the power converter according to the first embodiment.

FIG. 6 is a first set of graphs for explaining the problem of the present application.

FIG. 7 is a second set of graphs for explaining the problem of the present application.

FIG. 8 is a block diagram illustrating an example of a configuration of a voltage command value calculation unit included in the controller according to the first embodiment.

FIG. 9 is a block diagram illustrating an example of a configuration of a speed control unit included in the voltage command value calculation unit according to the first embodiment.

FIG. 10 is a block diagram illustrating an example of a configuration of a vibration reduction control unit included in the voltage command value calculation unit according to the first embodiment.

FIG. 11 is a diagram illustrating an input/output relationship in a limit value calculation unit that generates a γ-axis current limit value as an input signal to a γ-axis current compensation unit according to the first embodiment.

FIG. 12 is a set of waveform graphs for explaining an operation of the γ-axis current compensation unit according to the first embodiment.

FIG. 13 is a flowchart for explaining the operation of the γ-axis current compensation unit included in the voltage command value calculation unit according to the first embodiment.

FIG. 14 is a block diagram illustrating an example of a configuration of a voltage command value calculation unit according to a modification of the first embodiment.

FIG. 15 is a flowchart for explaining an operation of a γ-axis current compensation unit illustrated in FIG. 14.

FIG. 16 is a set of graphs illustrating operation waveforms of main parts under γ-axis current compensation control according to the first embodiment.

FIG. 17 is a set of graphs for explaining an effect of the γ-axis current compensation control according to the first embodiment.

FIG. 18 is a diagram illustrating an example of a hardware configuration that implements the controller included in the power converter according to the first embodiment.

FIG. 19 is a diagram illustrating an example of a configuration of a refrigeration cycle applied apparatus according to a second embodiment.

### DETAILED DESCRIPTION

Hereinafter, a power converter, a motor drive apparatus, and a refrigeration cycle applied apparatus according to embodiments of the present disclosure will be described in detail with reference to the drawings.

### First Embodiment

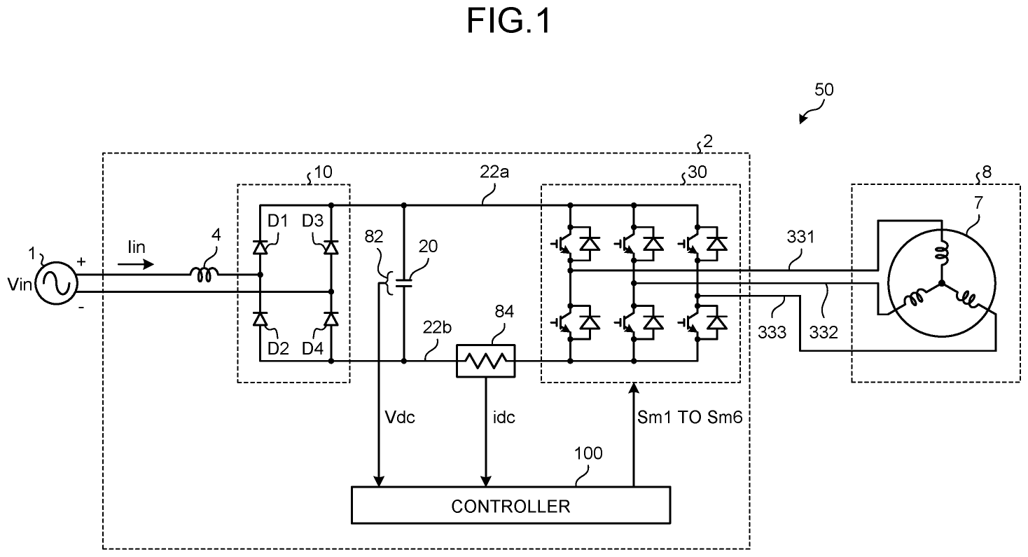

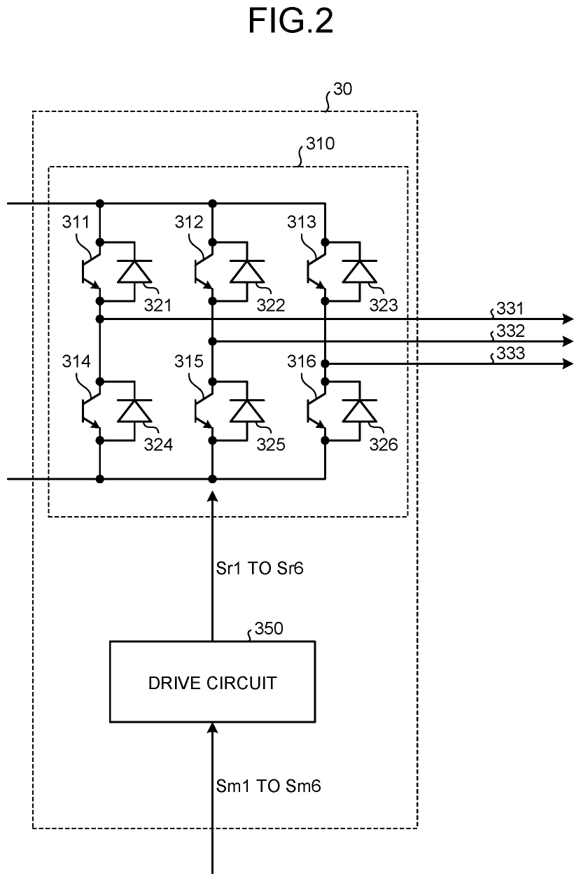

FIG. 1 is a diagram illustrating an example of a configuration of a power converter 2 according to a first embodiment. FIG. 2 is a diagram illustrating an example of a configuration of an inverter 30 included in the power converter 2 according to the first embodiment. The power converter 2 is connected to an alternating current power supply 1 and a compressor 8. The compressor 8 is an example of a load having a characteristic that, when driven, load torque fluctuates periodically. The compressor 8 includes a motor 7. An example of the motor 7 is a three-phase permanent magnet synchronous motor. The power converter 2 converts a power supply voltage Vin applied from the alternating current power supply 1 into an alternating current voltage having desired amplitude and phase, and applies the alternating current voltage to the motor 7. The power converter 2 includes a reactor 4, a converter 10, a capacitor 20, the inverter 30, a voltage detection unit 82, a current detection unit 84, and a controller 100. The power converter 2 and the motor 7 included in the compressor 8 are included in a motor drive apparatus 50.

The converter 10 includes four diodes D1, D2, D3, and D4. The four diodes D1 to D4 are bridge-connected to form a rectifier circuit. With the rectifier circuit including the four diodes D1 to D4, the converter 10 rectifies the power supply voltage Vin applied from the alternating current power supply 1. In the converter 10, one input end is connected to the alternating current power supply 1 via the reactor 4, and another input end is connected to the alternating current power supply 1. Moreover, an output side of the converter 10 is connected to the capacitor 20. In the configuration of FIG. 1, a power supply current Iin flows through the reactor 4. Note that there is also a configuration in which the reactor 4 is connected between the converter 10 and the capacitor 20, that is, to the output side of the converter 10.

The converter 10 may have, along with the rectifying function, a boosting function of boosting the rectified voltage. The converter having the boosting function can include, in addition to or instead of the diode, one or more transistor elements or one or more switching elements in which the transistor element and the diode are connected in antiparallel. Note that, in the converter having the boosting function, the placement and connection of the transistor element or the switching element are known and will not be described here.

The capacitor 20 is connected to output ends of the converter 10 via direct current buses 22a and 22b. The direct current bus 22a is a positive direct current bus, and the direct current bus 22b is a negative direct current bus. The capacitor 20 smooths the rectified voltage applied from the converter 10. Examples of the capacitor 20 include an electrolytic capacitor and a film capacitor.

The inverter 30 is connected via the direct current buses 22a and 22b to the output ends of the converter 10 and across the capacitor 20. The inverter 30 converts the direct current voltage smoothed by the capacitor 20 into an alternating current voltage to be applied to the compressor 8, and applies the alternating current voltage to the motor 7 of the compressor 8. The voltage applied to the motor 7 is a three-phase alternating current voltage with variable frequency and variable voltage value.

As illustrated in FIG. 2, the inverter 30 includes an inverter main circuit 310 and a drive circuit 350. The inverter main circuit 310 includes switching elements 311 to 316. Rectifier elements 321 to 326 for reflux are connected in anti-parallel to the switching elements 311 to 316, respectively.

In the inverter main circuit 310, the switching elements 311 to 316 are each assumed to be an insulated gate bipolar transistor (IGBT), a metal oxide semiconductor field effect transistor (MOSFET), or the like but may each be any element as long as the element can perform switching. Note that, in a case where the switching elements 311 to 316 are each a MOSFET, which has a parasitic diode due to its structure, a similar effect can be obtained without the rectifier elements 321 to 326 for reflux connected in anti-parallel to the switching elements 311 to 316.

Moreover, the material used to form the switching elements 311 to 316 may be not only silicon (Si) but may be also silicon carbide (SiC), gallium nitride (GaN), diamond, or the like that is a wide band gap semiconductor. Using the wide band gap semiconductor to form the switching elements 311 to 316 can result in a smaller loss.

The drive circuit 350 generates drive signals Sr1 to Sr6 on the basis of pulse width modulation (PWM) signals Sm1 to Sm6 output from the controller 100. The drive circuit 350 uses the drive signals Sr1 to Sr6 to control on/off of the switching elements 311 to 316. As a result, the inverter 30 can apply the three-phase alternating current voltage with variable frequency and variable voltage to the motor 7 via output line 331 to 333.

The PWM signals Sm1 to Sm6 are signals having a signal level of a logic circuit, the signal level being a magnitude of 0 V to 5 V, for example. The PWM signals Sm1 to Sm6 are signals having the ground potential of the controller 100 as a reference potential. On the other hand, the drive signals Sr1 to Sr6 are signals having a voltage level necessary for controlling the switching elements 311 to 316, the voltage level being a magnitude of −15 V to +15 V, for example. The drive signals Sr1 to Sr6 are signals each having the potential of a negative terminal, that is, an emitter terminal of the corresponding switching element as a reference potential.

The voltage detection unit 82 detects a bus voltage Vdc by detecting a voltage across the capacitor 20. The bus voltage Vdc is a voltage between the direct current buses 22a and 22b. The voltage detection unit 82 includes, for example, a voltage divider circuit that divides the voltage with a resistor connected in series. The voltage detection unit 82 uses the voltage divider circuit to convert the bus voltage Vdc detected into a voltage suitable for processing in the controller 100, such as a voltage of 5 V or less, and outputs the voltage to the controller 100 as a detected voltage signal that is an analog signal. The detected voltage signal output from the voltage detection unit 82 to the controller 100 is converted from the analog signal to a digital signal by an analog to digital (AD) converter (not illustrated) in the controller 100, and is used for internal processing in the controller 100.

The current detection unit 84 includes a shunt resistor inserted in the direct current bus 22b. The current detection unit 84 uses the shunt resistor to detect a capacitor output current idc. The capacitor output current idc is an input current to the inverter 30, that is, a current output from the capacitor 20 to the inverter 30. The current detection unit 84 outputs the capacitor output current idc detected to the controller 100 as a detected current signal that is an analog signal. The detected current signal output from the current detection unit 84 to the controller 100 is converted from the analog signal to a digital signal by the AD converter (not illustrated) in the controller 100, and is used for internal processing in the controller 100.

The controller 100 generates the PWM signals Sm1 to Sm6 described above and controls the operation of the inverter 30. Specifically, on the basis of the PWM signals Sm1 to Sm6, the controller 100 changes an angular frequency ωe and a voltage value of the output voltage of the inverter 30.

The angular frequency ωe of the output voltage of the inverter 30 determines an angular velocity of rotation in electrical angle of the motor 7. In the present description, this angular velocity of rotation is also represented by the same reference sign “ωe”. An angular velocity of rotation ωm in mechanical angle of the motor 7 is equal to the angular velocity of rotation ωe in electrical angle of the motor 7 divided by the number of pole pairs P. Therefore, the angular velocity of rotation ωm in mechanical angle of the motor 7 and the angular frequency ωe of the output voltage of the inverter 30 have a relationship expressed by the following Formula (1). Note that, in the present description, the angular velocity of rotation may be simply referred to as “rotational speed”, and the angular frequency may be simply referred to as “frequency”.

$$\begin{matrix}Formula 1 & \\ ω m = ω e / P & ( 1 )\end{matrix}$$

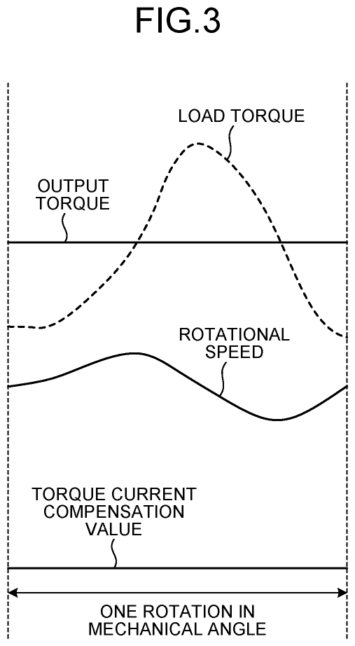

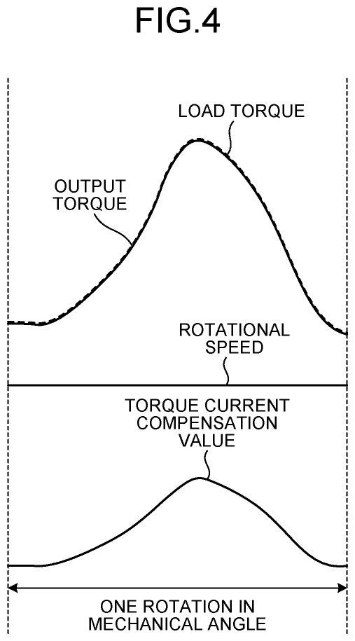

Next, vibration reduction control in the motor drive apparatus 50 and the necessity thereof will be described with reference to FIGS. 3 and 4. FIG. 3 is a graph illustrating a state of operation without vibration reduction control of the motor drive apparatus 50 according to the first embodiment. FIG. 4 is a graph illustrating a state of operation with vibration reduction control of the motor drive apparatus 50 according to the first embodiment.

In a case where the motor drive apparatus 50 is applied to, for example, an air conditioner, in order to reduce vibration of the compressor 8, control is performed so as to reduce fluctuations in the rotational speed of the motor 7. When the fluctuations in the rotational speed of the motor 7 are reduced, the vibration of the compressor 8 is reduced. Therefore, the control of reducing the fluctuations in the rotational speed to reduce the vibration of the compressor 8 is generally called “vibration reduction control”. Note that in the present description, this vibration reduction control may be referred to as “first control”.

FIGS. 3 and 4 illustrate a relationship among a load torque of the compressor 8, an output torque of the motor 7, the rotational speed of the motor 7, and a torque current compensation value in the controller 100 during one rotation in mechanical angle of the motor 7 in a case where the compressor 8 is a single rotary compressor. FIG. 3 illustrates a state in which the controller 100 controls the output torque of the motor 7 to be constant. On the other hand, FIG. 4 illustrates a state in which the controller 100 controls the torque current compensation value such that the output torque of the motor 7 matches the load torque of the compressor 8, thereby controlling the rotational speed to be constant.

As can be seen from FIG. 3, when the controller 100 controls the output torque of the motor 7 to be constant, the rotational speed fluctuates due to a difference between the output torque of the motor 7 and the load torque of the compressor 8. The fluctuations in the rotational speed cause vibration, noise, and the like in the compressor 8. When the fluctuations in the rotational speed become extremely large, there is a possibility that the motor 7 may be out of step and stop.

Therefore, the controller 100 according to the first embodiment includes the function of vibration reduction control for performing control such that the output torque of the motor 7 matches the load torque of the compressor 8. Details of the vibration reduction control will be described later.

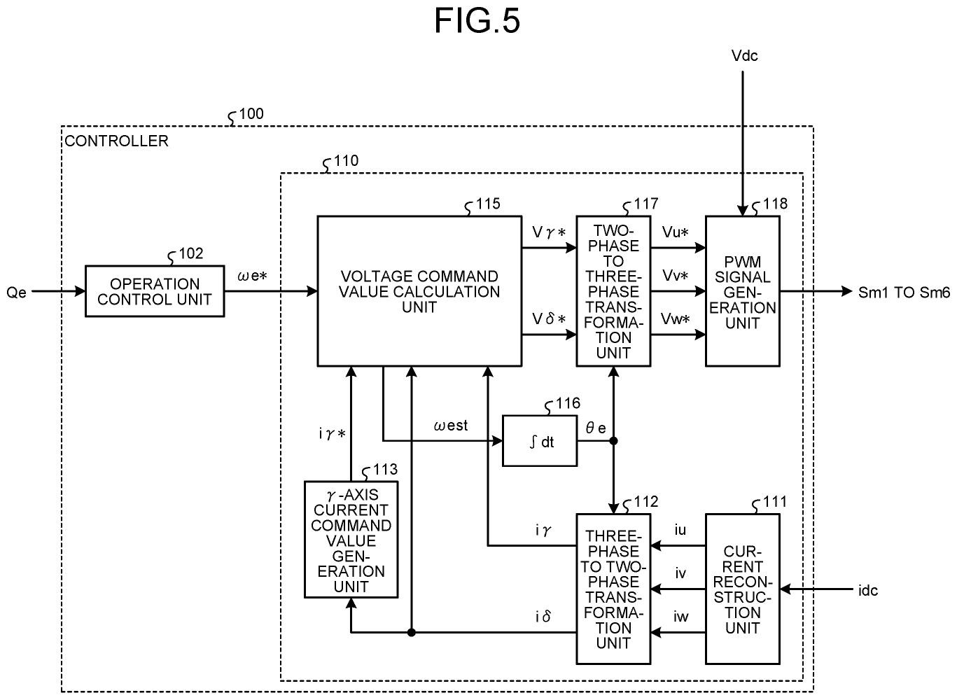

Next, a configuration of the controller 100 will be described with reference to FIG. 5. Note that, in the present description, a coordinate system for control units set up in the controller 100 is a γ-δ axis coordinate system generally used in position sensorless control, but the coordinate system for the control units is not limited thereto. For example, in a case where the motor 7 is a permanent magnet motor, a d-q axis coordinate system may be used with an N-pole of the magnetic pole being a d-axis and an axis orthogonal to the d-axis being a q-axis. At this time, in the processing of the controller 100, if a γ-axis is set such that there is no axial error between the γ-axis and the d-axis, the γ-axis and a δ-axis can be treated as the d-axis and the q-axis, respectively. Even when there is an axial error between the γ-axis and the d-axis, as long as a control value is handled in consideration of a difference corresponding to the axial error, the γ-axis and the δ-axis can be regarded as the d-axis and the q-axis, respectively.

FIG. 5 is a block diagram illustrating an example of the configuration of the controller 100 included in the power converter 2 according to the first embodiment. The controller 100 includes an operation control unit 102 and an inverter control unit 110.

The operation control unit 102 receives command information Qe from the outside and generates a frequency command value ωe* on the basis of the command information Qe. As expressed by the following Formula (2), the frequency command value ωe* can be obtained by multiplying a rotational speed command value ωm*, which is a command value of the rotational speed of the motor 7, by the number of pole pairs P.

$$\begin{matrix}Formula 2 & \\ ω e *= ω m * \cdot P & ( 2 )\end{matrix}$$

When controlling the air conditioner as the refrigeration cycle applied apparatus, the controller 100 controls the operation of each unit of the air conditioner on the basis of the command information Qe. The command information Qe is, for example, a temperature detected by a temperature sensor (not illustrated), information indicating a set temperature instructed from a remote control that is an operation unit (not illustrated), operation mode selection information, operation start and operation end instruction information, and the like. The operation mode includes, for example, heating, cooling, dehumidifying, and the like. Note that the operation control unit 102 may be placed outside the controller 100. That is, the controller 100 may be configured to acquire the frequency command value ωe* from the outside.

The inverter control unit 110 includes a current reconstruction unit 111, a three-phase to two-phase transformation unit 112, a γ-axis current command value generation unit 113, a voltage command value calculation unit 115, an electrical phase calculation unit 116, a two-phase to three-phase transformation unit 117, and a PWM signal generation unit 118.

The current reconstruction unit 111 reconstructs phase currents iu, iv, and iw flowing to the motor 7 on the basis of the capacitor output current idc detected by the current detection unit 84. The current reconstruction unit 111 can reconstruct the phase currents iu, iv, and iw by sampling a detected value of the capacitor output current idc detected by the current detection unit 84 at a timing determined on the basis of the PWM signals Sm1 to Sm6 generated by the PWM signal generation unit 118. Note that a current detector may be provided in the output lines 331 to 333 to directly detect the phase currents iu, iv, and iw and input the phase currents iu, iv, and iw to the three-phase to two-phase transformation unit 112. In a case of this configuration, the current reconstruction unit 111 is unnecessary.

The three-phase to two-phase transformation unit 112 uses an electrical phase θe generated by the electrical phase calculation unit 116 described later to transform the phase currents iu, iv, and iw reconstructed by the current reconstruction unit 111 into a γ-axis current iγ as an excitation current and a δ-axis current iδ as a torque current, that is, γ-δ axis current values.

The γ-axis current command value generation unit 113 generates a γ-axis current command value iγ* as an excitation current command value on the basis of the δ-axis current iδ. More specifically, the γ-axis current command value generation unit 113 obtains a current phase angle at which the output torque of the motor 7 is equal to or larger than a set value or has the maximum value on the basis of the δ-axis current iδ, and calculates the γ-axis current command value iγ* on the basis of the obtained current phase angle. Note that, instead of the output torque of the motor 7, a motor current flowing through the motor 7 may be used. In this case, the γ-axis current command value iγ* is calculated on the basis of a current phase angle at which the motor current flowing through the motor 7 is equal to or less than a set value or has the minimum value. In the present description, the γ-axis current command value generation unit may be simply referred to as a “command value generation unit”.

Although FIG. 5 illustrates the configuration in which the γ-axis current command value iγ* is obtained on the basis of the δ-axis current iδ, the present disclosure is not limited to this configuration. Instead of the δ-axis current iδ, the γ-axis current iγ may be used to obtain the γ-axis current command value iγ*. The γ-axis current command value generation unit 113 may also determine the γ-axis current command value iγ* by flux weakening control.

The voltage command value calculation unit 115 generates a γ-axis voltage command value Vγ* and a δ-axis voltage command value Vδ* on the basis of the frequency command value ωe* acquired from the operation control unit 102, the γ-axis current iγ and the δ-axis current iδ acquired from the three-phase to two-phase transformation unit 112, and the γ-axis current command value iγ* acquired from the γ-axis current command value generation unit 113. Also, the voltage command value calculation unit 115 estimates an estimated frequency value ωest on the basis of the γ-axis voltage command value Vγ*, the δ-axis voltage command value Vδ*, the γ-axis current iγ, and the δ-axis current iδ.

The electrical phase calculation unit 116 calculates the electrical phase θe by integrating the estimated frequency value ωest acquired from the voltage command value calculation unit 115.

The two-phase to three-phase transformation unit 117 transforms the γ-axis voltage command value Vγ* and the δ-axis voltage command value Vδ* acquired from the voltage command value calculation unit 115, that is, voltage command values in a two-phase coordinate system into three-phase voltage command values Vu*, Vv*, and Vw*, which are output voltage command values in a three-phase coordinate system, by using the electrical phase θe acquired from the electrical phase calculation unit 116.

The PWM signal generation unit 118 compares the three-phase voltage command values Vu*, Vv*, and Vw* acquired from the two-phase to three-phase transformation unit 117 with the bus voltage Vdc detected by the voltage detection unit 82, thereby generating the PWM signals Sm1 to Sm6. Note that the PWM signal generation unit 118 can also stop the motor 7 by not outputting the PWM signals Sm1 to Sm6.

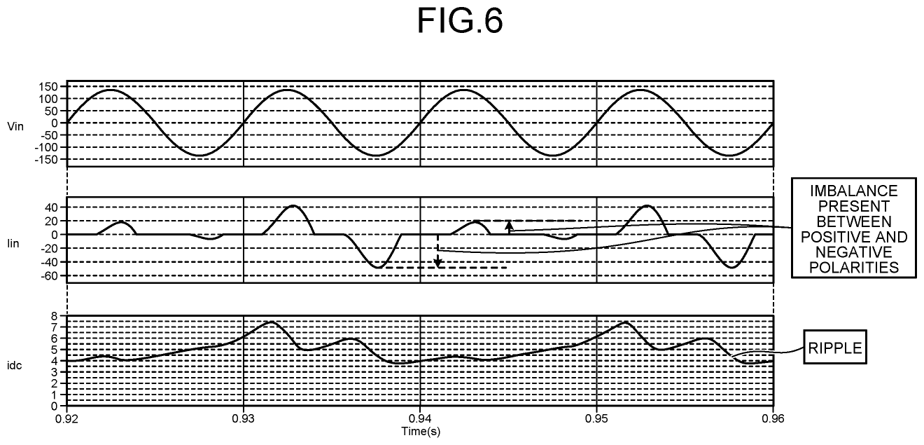

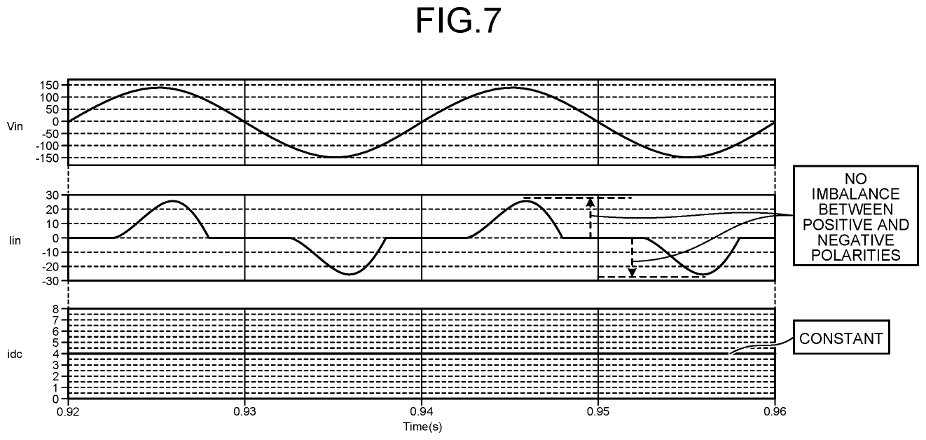

Next, reasons why the problem of the present application occurs will be described. FIGS. 6 and 7 are first and second sets of graphs for explaining the problem of the present application, respectively. The problem of the present application has been briefly described in the section of [Problem to be solved by the Invention], but a more detailed description will be added here.

First, in a case where the load is a load having torque ripple such as a single rotary compressor, a scroll compressor, or a twin rotary compressor, the above-described vibration reduction control is performed. In the typical vibration reduction control, the torque current compensation value is generated such that the output torque of the motor 7 follows the torque ripple of the compressor 8, and the inverter 30 is controlled. However, when this control is simply performed, as described in the section of [Problem to be solved by the Invention], the power supply current Iin has the imbalance between its positive and negative polarities, which results in the problem that the harmonic components of the power supply current Iin are increased.

FIGS. 6 and 7 illustrate, in order from the top graph, waveforms of the power supply voltage Vin, the power supply current Iin, and the capacitor output current idc. The horizontal axes in FIGS. 6 and 7 represent time.

The middle graph of FIG. 6 illustrates a state in which a peak value of the waveform on the positive side and a peak value of the waveform on the negative side of the power supply current Iin are different, that is, a state in which the power supply current Iin has an imbalance in peak values between its positive and negative polarities. Such an imbalance causes ripple in the capacitor output current idc as illustrated in the bottom graph. As a result, the power supply current Iin contains many harmonic components.

Note that, it has been found by the inventors of the present application that the ripple of the capacitor output current idc increases as the load torque increases and the inertia of the load decreases, and remarkably appears when the load torque is large during the vibration reduction control. In addition, it has been found by the inventors of the present application that the ripple of the capacitor output current idc is larger in the single rotary compressor than in the twin rotary compressor and the scroll compressor.

The bottom graph of FIG. 7 illustrates an ideal state in which the capacitor output current idc is constant. In such an ideal state, as illustrated in the middle graph of FIG. 7, the peak value of the waveform on the positive side and the peak value of the waveform on the negative side of the power supply current Iin are equal, and no imbalance occurs between the positive and negative polarities of the power supply current Iin. Therefore, the harmonic components that can be contained in the power supply current Iin are much less than those in the case of FIG. 6.

As described above, the harmonic components that can be contained in the power supply current Iin are related to the ripple of the capacitor output current idc. Thus, the voltage command value calculation unit 115 included in the controller 100 according to the first embodiment performs control to reduce the harmonic components that can be contained in the power supply current Iin when the vibration reduction control is performed. Note that in the present description, this control may be referred to as “second control”.

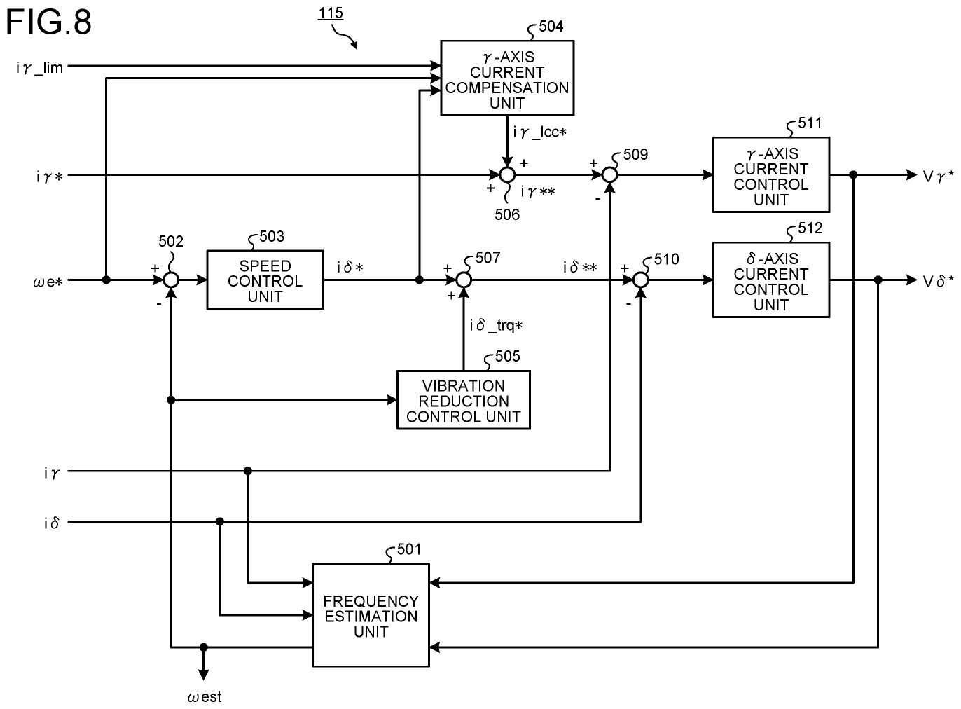

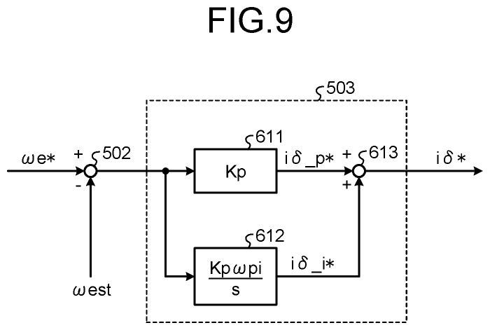

FIG. 8 is a block diagram illustrating an example of a configuration of the voltage command value calculation unit 115 included in the controller 100 according to the first embodiment. As illustrated in FIG. 8, the voltage command value calculation unit 115 includes a frequency estimation unit 501, subtraction units 502, 509, and 510, a speed control unit 503, a γ-axis current compensation unit 504, a vibration reduction control unit 505, addition units 506 and 507, a γ-axis current control unit 511, and a δ-axis current control unit 512. FIG. 9 is a block diagram illustrating an example of a configuration of the speed control unit 503 included in the voltage command value calculation unit 115 according to the first embodiment. Note that FIG. 9 also illustrates the subtraction unit 502 placed in a stage preceding the speed control unit 503.

The frequency estimation unit 501 estimates the frequency of the voltage applied to the motor 7 on the basis of the γ-axis current iγ, the δ-axis current iδ, the γ-axis voltage command value Vγ*, and the δ-axis voltage command value Vδ*, and outputs the estimated frequency as the estimated frequency value ωest.

The subtraction unit 502 calculates a difference (ωe*−ωest) between the frequency command value ωe* and the estimated frequency value ωest estimated by the frequency estimation unit 501.

The speed control unit 503 generates a δ-axis current command value iδ* that is a torque current command value in a rotating coordinate system. More specifically, the speed control unit 503 performs proportional integral operation, that is, proportional integral (PI) control on the difference (ωe*−ωest) calculated by the subtraction unit 502, and calculates the δ-axis current command value iδ* that brings the difference (ωe*−ωest) close to zero.

FIG. 9 illustrates the example of the configuration of the speed control unit 503. As illustrated in FIG. 9, the speed control unit 503 is a control unit that generates a current command value on the basis of a frequency deviation. The speed control unit 503 includes a proportional control unit 611, an integral control unit 612, and an addition unit 613.

In the speed control unit 503, the proportional control unit 611 performs proportional control on the difference (ωe*−ωest) between the frequency command value ωe* and the estimated frequency value ωest acquired from the subtraction unit 502, and outputs a proportional term iδ_p*. The integral control unit 612 performs integral control on the difference (ωe*−ωest) between the frequency command value ωe* and the estimated frequency value ωest acquired from the subtraction unit 502, and outputs an integral term iδ_i*. The addition unit 613 adds the proportional term iδ_p* acquired from the proportional control unit 611 and the integral term iδ_i* acquired from the integral control unit 612, thereby generating the δ-axis current command value iδ*.

As described above, the speed control unit 503 generates and outputs the δ-axis current command value iδ* that matches the estimated frequency value ωest with the frequency command value ωe*.

Returning to FIG. 8, the vibration reduction control unit 505 generates, on the basis of the estimated frequency value ωest acquired from the frequency estimation unit 501, a δ-axis current compensation value iδ_trq* that is a compensation value of the δ-axis current command value iδ* in the vibration reduction control. Specifically, the vibration reduction control unit 505 generates the δ-axis current compensation value iδ_trq* such that the output torque of the motor 7 follows periodic fluctuations of the load torque of the compressor 8.

The δ-axis current compensation value iδ_trq* is a component of a control value for reducing a ripple component of the estimated frequency value ωest, particularly, a ripple component having a frequency of ωmn. Here, the “ripple component of the estimated frequency value ωest, particularly, the ripple component having the frequency of ωmn” refers to a ripple component of a direct current value that is a value representing the estimated frequency value ωest, particularly, a ripple component having a ripple frequency of ωmn. Note that “m” is a parameter related to the direct current value, and “n” is a parameter indicating the compressor 8 that is the load driven by the motor 7. For example, the parameter “n” is “1” when the compressor 8 is a single rotary compressor, and is “2” when the compressor 8 is a twin rotary compressor. The parameter “n” may be “3” or more. Note that, in the present description, the δ-axis current compensation value may be referred to as a “torque current compensation value”.

The γ-axis current compensation unit 504 generates a γ-axis current compensation value iγ_lcc* on the basis of the frequency command value ωe*, the δ-axis current command value iδ* output from the speed control unit 503, and a γ-axis current limit value iγ_lim. The γ-axis current compensation value iγ_lcc* is a component of a control value for reducing the ripple component of the capacitor output current idc. Moreover, the γ-axis current limit value iγ_lim is a limit value of the γ-axis current compensation value iγ_lcc* that determines an upper limit of the γ-axis current compensation value iγ_lcc*. Details of the γ-axis current compensation value iγ_lcc* and the γ-axis current limit value iγ_lim will be described later. Note that, in the present description, the γ-axis current compensation unit may be simply referred to as a “current compensation unit”, and the γ-axis current compensation value may be referred to as an “excitation current compensation value”. Also, in the present description, the control by the γ-axis current compensation unit 504 may be referred to as “γ-axis current compensation control”.

The addition unit 506 adds the γ-axis current command value iγ* and the γ-axis current compensation value iγ_lcc* acquired from the γ-axis current compensation unit 504, that is, superimposes the γ-axis current compensation value iγ_lcc* on the γ-axis current command value iγ*, thereby generating a γ-axis current command value iγ**. The γ-axis current command value iγ** generated is input to the subtraction unit 509.

The addition unit 507 adds the δ-axis current command value iδ* and the δ-axis current compensation value iδ_trq* acquired from the vibration reduction control unit 505, that is, superimposes the δ-axis current compensation value iδ_trq* on the δ-axis current command value iδ*, thereby generating a δ-axis current command value iδ**. The δ-axis current command value iδ** generated is input to the subtraction unit 510.

The subtraction unit 509 calculates a difference (iγ**−iγ) between the γ-axis current command value iγ** and the γ-axis current iγ. The subtraction unit 510 calculates a difference (iδ**−iδ) between the δ-axis current command value iδ** and the δ-axis current iδ.

The γ-axis current control unit 511 performs proportional integral operation on the difference (iγ**−iγ) calculated by the subtraction unit 509 to generate the γ-axis voltage command value Vγ* that brings the difference (iγ**−iγ) close to zero. The γ-axis current control unit 511 generates the γ-axis voltage command value Vγ* to perform control that matches the γ-axis current iγ with the γ-axis current command value iγ**.

The δ-axis current control unit 512 performs proportional integral operation on the difference (iδ**−iδ) calculated by the subtraction unit 510 to generate the δ-axis voltage command value Vδ* that brings the difference (iδ**−iδ) close to zero. The δ-axis current control unit 512 generates the δ-axis voltage command value Vδ* to perform control that matches the δ-axis current iδ with the δ-axis current command value iδ**.

In the above control, the γ-axis current command value iγ** output from the subtraction unit 509 and input to the γ-axis current control unit 511 includes the γ-axis current compensation value iγ_lcc* acquired from the γ-axis current compensation unit 504. Therefore, when the γ-axis current control unit 511 controls the inverter 30 on the basis of the γ-axis voltage command value Vγ* generated on the basis of the γ-axis current compensation value iγ_lcc*, the ripple of the capacitor output current idc can be reduced.

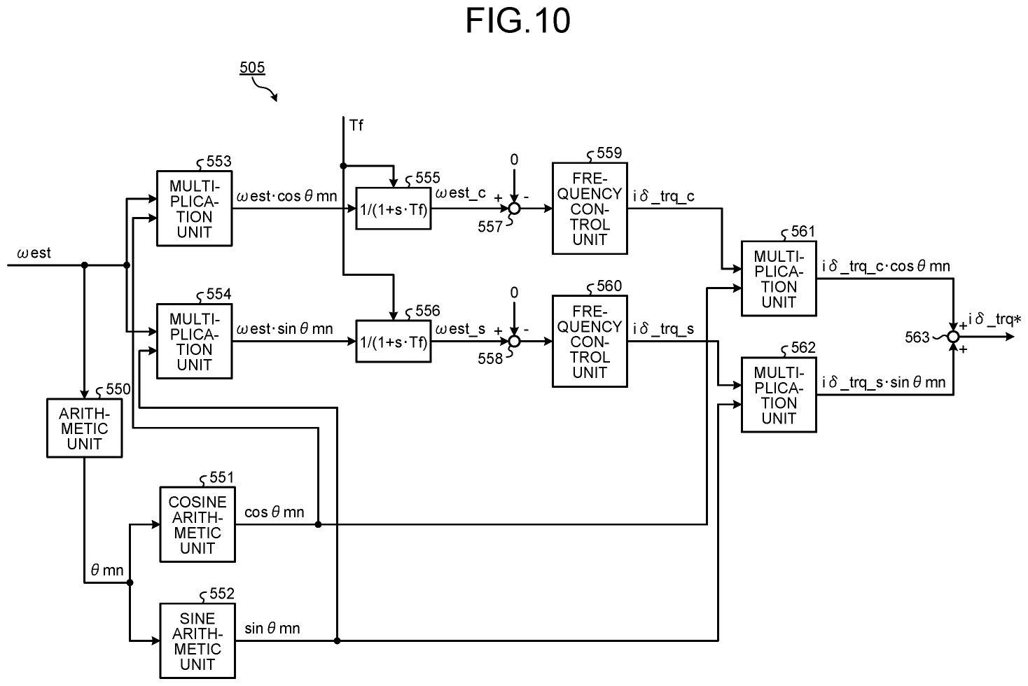

Next, a configuration of the vibration reduction control unit 505 will be described. FIG. 10 is a block diagram illustrating an example of the configuration of the vibration reduction control unit 505 included in the voltage command value calculation unit 115 according to the first embodiment. The vibration reduction control unit 505 includes an arithmetic unit 550, a cosine arithmetic unit 551, a sine arithmetic unit 552, multiplication units 553 and 554, low-pass filters 555 and 556, subtraction units 557 and 558, frequency control units 559 and 560, multiplication units 561 and 562, and an addition unit 563.

The arithmetic unit 550 calculates a mechanical angle phase θmn indicating a rotary position of the motor 7 by integrating the estimated frequency value ωest and dividing the integration result by the number of pole pairs P. The cosine arithmetic unit 551 calculates a cosine value cos θmn on the basis of the mechanical angle phase θmn. The sine arithmetic unit 552 calculates a sine value sin θmn on the basis of the mechanical angle phase θmn.

The multiplication unit 553 multiplies the estimated frequency value ωest by the cosine value cos θmn to calculate a cosine component ωest·cos θmn of the estimated frequency value ωest. The multiplication unit 554 multiplies the estimated frequency value ωest by the sine value sin θmn to calculate a sine component ωest·sin θmn of the estimated frequency value ωest. The cosine component ωest·cos θmn and the sine component ωest·sin θmn calculated by the multiplication units 553 and 554 contain the ripple component having the frequency of ωmn and also a ripple component having a frequency higher than ωmn, that is, a harmonic component.

The low-pass filters 555 and 556 are each a first-order lag filter whose transfer function is expressed as 1/(1+s·Tf). Here, “s” represents a Laplace operator. Also, “Tf” is a time constant and is determined so as to remove the ripple component having the frequency higher than the frequency ωmn. Note that the word “remove” includes a case where a part of the ripple component is attenuated, that is, reduced. The time constant Tf is set by the operation control unit 102 on the basis of the speed command value, and the operation control unit 102 may notify the low-pass filters 555 and 556 of the time constant Tf, or the low-pass filters 555 and 556 may hold the time constant Tf. The low-pass filters 555 and 556 are each the first-order lag filter as an example, and may each be a moving average filter or the like not limited in the filter type as long as the ripple component on the harmonic side can be removed.

The low-pass filter 555 performs low-pass filtering on the cosine component west cos θmn to remove the ripple component having the frequency higher than the frequency ωmn, and outputs a low-frequency component ωest_c. The low-frequency component ωest_c is a direct current value representing the cosine component having the frequency of ωmn among the ripple components of the estimated frequency value ωest.

The low-pass filter 556 performs low-pass filtering on the sine component ωest·sin θmn to remove the ripple component having the frequency higher than the frequency ωmn, and outputs a low-frequency component ωest_s. The low-frequency component ωest_s is a direct current value representing the sine component having the frequency of ωmn among the ripple components of the estimated frequency value ωest.

The subtraction unit 557 calculates a difference (ωest_c−0) between the low-frequency component ωest_c output from the low-pass filter 555 and zero. The subtraction unit 558 calculates a difference (ωest_s−0) between the low-frequency component ωest_s output from the low-pass filter 556 and zero.

The frequency control unit 559 performs proportional integral operation on the difference (ωest_c−0) calculated by the subtraction unit 557 to calculate a cosine component iδ_trq_c of the current command value that brings the difference (ωest_c−0) close to zero. The frequency control unit 559 generates the cosine component iδ_trq_c in this manner to perform control by which the low-frequency component ωest_c matches zero.

The frequency control unit 560 performs proportional integral operation on the difference (ωest_s−0) calculated by the subtraction unit 558 to calculate a sine component iδ_trq_s of the current command value that brings the difference (ωest_s−0) close to zero. The frequency control unit 560 generates the sine component iδ_trq_s in this manner to perform control by which the low-frequency component ωest_s matches zero.

The multiplication unit 561 multiplies the cosine component iδ_trq_c output from the frequency control unit 559 by the cosine value cos θmn to generate iδ_trq_c·cos θmn. The value iδ_trq_c·cos θmn is an alternating current component having a frequency of n·ωest.

The multiplication unit 562 multiplies the sine component iδ_trq_s output from the frequency control unit 560 by the sine value sin θmn to generate iδ_trq_s·sin θmn. The value iδ_trq_s·sin θmn is an alternating current component having the frequency of n·ωest.

The addition unit 563 obtains a sum of iδ_trq_c·cos θmn output from the multiplication unit 561 and iδ_trq_s·sin θmn output from the multiplication unit 562. The vibration reduction control unit 505 outputs the result obtained by the addition unit 563 as the δ-axis current compensation value iδ_trq*.

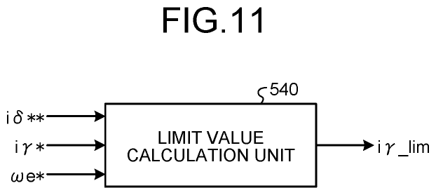

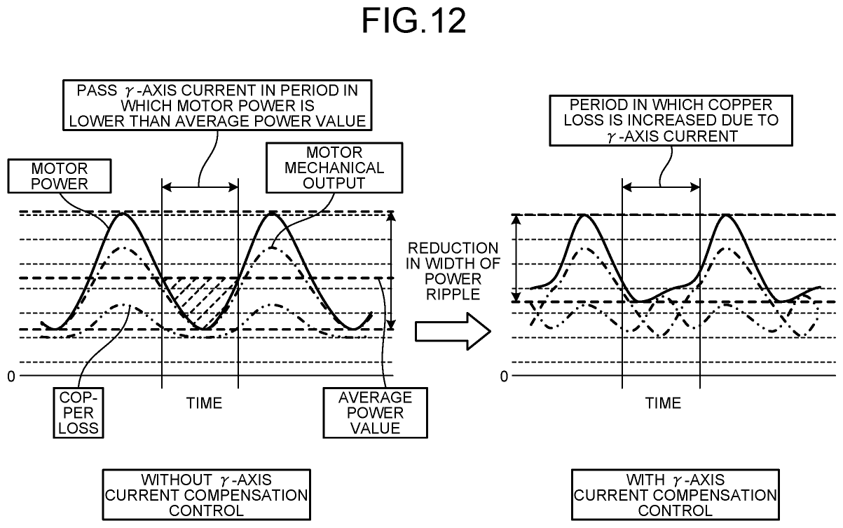

Next, the main points of the operation of the γ-axis current compensation unit 504 included in the voltage command value calculation unit 115 according to the first embodiment will be described with reference to some formulas and FIGS. 11 and 12. FIG. 11 is a diagram illustrating an input/output relationship in the limit value calculation unit 540 that generates the γ-axis current limit value iγ_lim as the input signal to the γ-axis current compensation unit 504 according to the first embodiment. FIG. 12 is a set of waveform graphs for explaining the operation of the γ-axis current compensation unit 504 according to the first embodiment.

First, motor power that is active power supplied from the inverter 30 to the motor 7 is represented by Pm. The motor power Pm can be expressed by the following Formula (3).

$$\begin{matrix}Formula 3 & \\ \begin{matrix}Pm = V γ \cdot i γ + V δ \cdot i δ = ( Ra \cdot i γ - ω e \cdot L δ \cdot i δ ) i γ + \\ ( Ra \cdot i δ + ω e ( L γ \cdot i γ + φ a ) i δ \\ = Ra \cdot i {γ}^{2} - ω e \cdot L δ \cdot i δ \cdot i γ + \\ Ra \cdot i {δ}^{2} + ω e ( L γ \cdot i γ + φ a ) i δ \\ = Ra ( i {γ}^{2} + i {δ}^{2} ) + ω e \cdot i δ ( φ a + ( L γ - L δ ) i γ )\end{matrix} & ( 3 )\end{matrix}$$

The meanings of the symbols shown in the above Formula (3) are as follows.
Vγ: γ-axis voltage of the motor 7
Vδ: δ-axis voltage of the motor 7
iγ: γ-axis current flowing through the motor 7
iδ: δ-axis current flowing through the motor 7
Ra: phase resistance of the motor 7
ωe: frequency (electrical angle) of the output voltage of the inverter 30
Lγ: γ-axis inductance of the motor 7
Lδ: δ-axis inductance of the motor 7
φa: induced voltage constant of the motor 7

Moreover, when the power supplied from the capacitor 20 to the inverter 30 is represented by Pdc, it can be regarded that the powers as being Pm≈Pdc. Therefore, from the above Formula (3), the capacitor output current idc can be expressed by the following Formula (4).

$$\begin{matrix}Formula 4 & \\ \begin{matrix}idc = Pdc / Vdc {}^{.} {=}_{.} Pm / Vdc \\ = Ra ( i {γ}^{2} + i {δ}^{2} ) / Vdc + ω e \cdot i δ ( φ a + ( L γ - L δ ) i γ ) / Vdc\end{matrix} & ( 4 )\end{matrix}$$

The first term on the right side of the above Formula (4) is a term representing a copper loss of the motor 7, and the second term on the right side of the above Formula (4) is a term representing a mechanical output of the motor 7 (hereinafter referred to as “motor mechanical output”). That is, it can be known that the capacitor output current idc is affected by the copper loss of the motor 7 and the motor mechanical output.

Next, the γ-axis current limit value iγ_lim will be described. As described above, the γ-axis current limit value iγ_lim is the limit value of the γ-axis current compensation value iγ_lcc* that determines the upper limit of the γ-axis current compensation value iγ_lcc*. A first limit value iγ_lim1, which is one of candidates for the y-axis current limit value iγ_lim, can be determined using the following Formula (5), for example.

$$\begin{matrix}Formula 5 & \\ iγ\_lim1 = \sqrt{3 {Ie}^{2} - i δ {**}^{2}} - \vert i γ * \vert & ( 5 )\end{matrix}$$

In the above Formula (5), “Ie” represents an effective value of the limit values of the phase currents iu, iv, and iw determined from an overcurrent cut-off protection threshold of the inverter 30, and is generally set to be lower than the overcurrent cut-off protection threshold by about 10% to 20%. As shown in the above Formula (5), the first limit value iγ_lim1 can be obtained by taking a square root of a value obtained by subtracting a square value of the δ-axis current command value iδ** from a value obtained by multiplying a square value of the effective value Ie by three, and further subtracting an absolute value of the γ-axis current command value iγ* from the square root. The use of the first limit value iγ_lim1 can secure, for example, the γ-axis current command value iγ** necessary for the flux weakening control while securing the δ-axis current command value iδ** necessary for the speed control and vibration reduction control for the motor 7.

The above Formula (5) can be used as it is for a low speed range of the motor 7, but needs to be modified for a high speed range of the motor 7. This is because, in the high speed range, the δ-axis current that can flow is reduced due to the influence of voltage saturation. It is known that when the δ-axis current command value iδ** is excessive, control may become unstable due to a wind-up phenomenon of the integrator. The above Formula (5) does not take into consideration the reduction in the maximum δ-axis current accompanying the increase in speed. Accordingly, here, a formula is derived in consideration of the reduction in the maximum δ-axis current.

First, in the high speed region, when a limit value of the γδ-axis voltage is “Vom”, the relationship of the following Formula (6) is established with respect to the limit value Vom.

$$\begin{matrix}Formula 6 & \\ {( φ a + L γ \cdot i γ )}^{2} + {( L δ \cdot i δ )}^{2} = {( \frac{Vom}{ω e \cdot L δ} )}^{2} & ( 6 )\end{matrix}$$

The limit value Vom in the above Formula (6) represents the radius of a voltage limit circle on a γδ plane, and there is a relationship of (Vγ**)²+(Vδ**)²=Vom² among the δ-axis current command value iδ**, the γ-axis current command value iγ**, and the limit value Vom. The above Formula (6) is obtained by substituting corresponding elements of a voltage equation in a steady state into this equation and organizing the equation while ignoring a voltage drop due to armature resistance. Solving the Formula (6) for the γ-axis current iγ can obtain the following Formula (7).

$$\begin{matrix}Formula 7 & \\ i γ = \frac{- φ a \pm \sqrt{{( \frac{Vom}{ω e} )}^{2} - {( L δ \cdot i δ )}^{2}}}{L γ} & ( 7 )\end{matrix}$$

Therefore, a second limit value iγ_lim2, which is a limit value of the γ-axis current iγ when the δ-axis current iδ flows up to the δ-axis current command value iδ**, can be expressed as the following Formula (8).

$$\begin{matrix}Formula 8 & \\ iγ\_lim2 = \frac{- φ a \pm \sqrt{{{( \frac{Vom}{ω e} )}^{2} - ( L δ \cdot i δ \text{**)}}^{2}}}{L γ} & ( 8 )\end{matrix}$$

As a final conclusion, the γ-axis current limit value iγ_lim is set as in the following Formula (9) in consideration of both the above Formulas (5) and (8).

$$\begin{matrix}Formula 9 & \\ iγ\_lim = MIN ( iγ\_lim1 , iγ\_lim2 ) & ( 9 )\end{matrix}$$

In the above Formula (9), “MIN” is a function for selecting the minimum.

In order to perform the calculation of the above Formula (9), the limit value calculation unit 540 illustrated in FIG. 11 is provided at a stage preceding the γ-axis current compensation unit 504. The limit value calculation unit 540 performs the calculations of the above Formulas (5) and (8), and outputs the smaller one of the calculated values to the γ-axis current compensation unit 504 as the γ-axis current limit value iγ_lim.

The left graph of FIG. 12 illustrates waveforms related to the motor power Pm, the motor mechanical output, and the copper loss of the motor 7 in a case where the γ-axis current compensation control is not performed. The case where the γ-axis current compensation control is not performed means that the γ-axis current compensation control function is not active. The right graph of FIG. 12 illustrates waveforms related to the motor power Pm, the motor mechanical output, and the copper loss of the motor 7 in a case where the γ-axis current compensation control is performed. The case where the γ-axis current compensation control is performed means that the γ-axis current compensation control function is active. In both of the graphs, a solid line represents the motor power Pm, a dash dot line represents the motor mechanical output, and a dash dot dot line represents the copper loss of the motor 7. Also, the horizontal axis represent time. Note that, in order to prevent the γ-axis current compensation control function from being active, it is necessary to stop the operation of the γ-axis current compensation unit 504 in FIG. 8 or prevent the output of the γ-axis current compensation unit 504 from being input to the addition unit 506.

As described above, the compressor 8 is the load having torque ripple. Therefore, speed ripple and ripple of the δ-axis current inevitably occur, which as a result also causes ripple of the motor power Pm and the motor mechanical output as illustrated in the left graph of FIG. 12. Moreover, in the above Formula (4), the power of the second term on the right side representing the motor mechanical output is dominant as compared to the power of the first term on the right side representing the copper loss of the motor 7. Therefore, when ripple occurs in the power of the second term on the right side, the ripple of the capacitor output current idc also increases so that the harmonic components contained in the power supply current Iin are increased.

Thus, in the first embodiment, in order to reduce the ripple of the capacitor output current idc, control is performed to increase the copper loss of the motor 7 in a period in which the motor power Pm is lower than a set power value. Note that, in the present description, the period in which the motor power Pm is lower than the set power value is referred to as a “first period” as appropriate.

Here, as can be understood from the first term and the second term on the right side of the above Formula (4), an increase in the δ-axis current iδ increases the copper loss of the motor 7 but also increases the mechanical output of the motor 7. Thus, the first embodiment adopts a method of increasing the γ-axis current iγ to increase the copper loss of the motor 7.

The left graph of FIG. 12 illustrates an example of a case where the set power value is an average power value Pavg that is an average value of the motor power Pm. Note that the average power value Pavg mentioned here is the average value of the motor power Pm when the γ-axis current compensation control according to the first embodiment is not performed. Moreover, in the left graph of FIG. 12, an area enclosed by the motor power Pm and the average power value Pavg is indicated by hatching. The width in the time axis direction of the area indicated by the hatching corresponds to the first period described above. In addition, the right graph of FIG. 12 illustrates that the control of increasing the γ-axis current iγ causes, in the first period, an increase in the copper loss of the motor 7, raising of the waveform of a downwardly convex portion of the motor power Pm, and a reduction in the width of ripple of the motor power Pm.

Note that the γ-axis current iγ may flow in either a positive or negative direction. Since the copper loss of the motor 7 is directly proportional to the square of the current, the current flowing in either the positive or negative direction can cause the copper loss in the motor 7. Therefore, in order to increase the copper loss of the motor 7, the absolute value of the γ-axis current iγ need only be increased.

In a case where the motor 7 is an embedded permanent magnet motor, for example, the direction in which the γ-axis current iγ flows is preferably negative. This point will be described below.

In the second term on the right side of the above Formula (4), “(Lγ−Lδ)iγ” is a term representing power related to reluctance torque. In the case where the motor 7 is the embedded permanent magnet motor, γ-axis inductance Lγ and δ-axis inductance Lδ generally have a relationship of Lγ<Lδ. This relationship is referred to as having “inverse saliency”. In the case where the motor 7 has inverse saliency, when the γ-axis current iγ flows in the negative direction, the above-described term “(Lγ−Lδ)iγ” has a positive value. Therefore, when the γ-axis current iγ flows in the negative direction, the reluctance torque has a positive value so that the control is performed in a direction in which the driving of the motor 7 is stabilized. This can keep down the possibility of the motor 7 being out of step while preventing an increase in the harmonic components of the power supply current.

Moreover, in a case where the power converter 2 has the function of flux weakening control and the motor 7 has inverse saliency, the γ-axis current iγ is passed in the negative direction when flux weakening control is performed in the overmodulation region. Therefore, the control of passing the γ-axis current iγ in the negative direction is advantageous for flux weakening control of the motor 7 having inverse saliency.

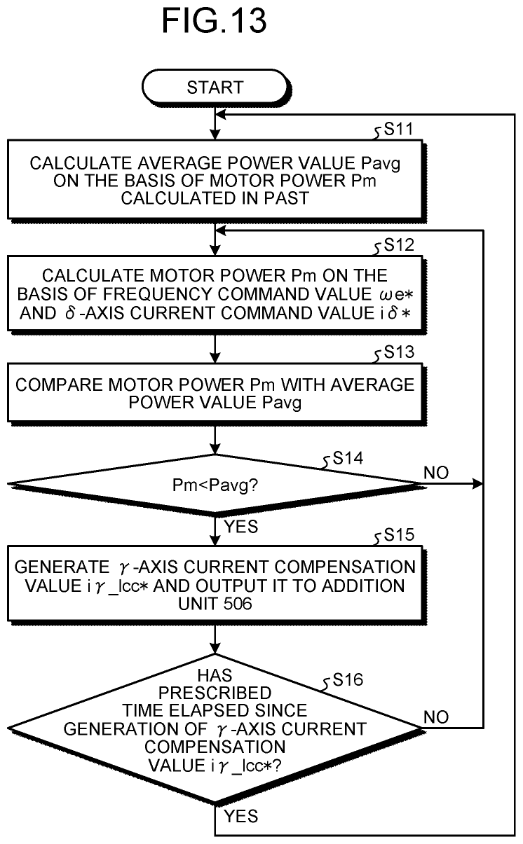

FIG. 13 is a flowchart for explaining the operation of the γ-axis current compensation unit 504 included in the voltage command value calculation unit 115 according to the first embodiment.

In the controller 100, the γ-axis current compensation unit 504 calculates the average power value Pavg on the basis of the motor power Pm calculated in the past (step S11). The γ-axis current compensation unit 504 also calculates the current motor power Pm on the basis of the frequency command value ωe* and the δ-axis current command value iδ* (step S12). Furthermore, the γ-axis current compensation unit 504 compares the motor power Pm with the average power value Pavg (step S13).

If the motor power Pm is not lower than the average power value Pavg (No in step S14), the processing returns to step S12, and the processing of steps S12 and S13 is repeated. On the other hand, if the motor power Pm is lower than the average power value Pavg (Yes in step S14), the γ-axis current compensation unit 504 generates the γ-axis current compensation value iγ_lcc* and outputs the γ-axis current compensation value iγ_lcc* to the addition unit 506 (step S15). The γ-axis current compensation unit 504 determines whether or not a prescribed time has elapsed since the generation of the γ-axis current compensation value iγ_lcc* (step S16). If the prescribed time has not elapsed (No in step S16), the processing returns to step S12, and the processing from step S12 is repeated. On the other hand, if the prescribed time has elapsed (Yes in step S16), the processing returns to step S11, and the processing from step S11 is repeated.

The above processing will be partially supplemented. In step S15, the absolute value of the γ-axis current compensation value iγ_lcc* output to the addition unit 506 is controlled so as not to exceed the γ-axis current limit value iγ_lim. Such control can lower the priority of the γ-axis current compensation control with respect to other controls, specifically, the vibration reduction control and the flux weakening control. This can determine the γ-axis current iγ that can be passed to the maximum in the γ-axis current compensation control while preventing interference with the other controls.

Note that, according to the γ-axis current compensation control using the γ-axis current limit value iγ_lim, the shape of the γ-axis current compensation value iγ_lcc* is a rectangular wave, but is not necessarily limited to the rectangular wave. The shape of the γ-axis current compensation value iγ_lcc* may be a triangular wave, a trapezoidal wave, or a sine wave having the maximum amplitude at the γ-axis current limit value iγ_lim.

The prescribed time in step S16 can be determined on the basis of the cycle of the motor power Pm and the average power value Pavg. Moreover, the average power value Pavg in step S11 may be calculated on the basis of the motor power Pm one cycle before, or may be calculated on the basis of the motor power Pm of a plurality of cycles including one cycle before. Moreover, in step S12, the motor power Pm is calculated on the basis of not a measurement value but the frequency command value ωe* and the δ-axis current command value iδ* that are command values, so that it is possible to grasp the motor power Pm when the γ-axis current compensation control is not performed.

In the flowchart of FIG. 13, the γ-axis current compensation value iγ_lcc* is calculated on the basis of the motor power Pm and its average value, that is, the average power value Pavg, but the present disclosure is not limited to this calculation. The rotational speed of the motor 7 may be regarded as being constant, and the γ-axis current compensation value iγ_lcc* may be calculated on the basis of the δ-axis current command value iδ* and its average value. Alternatively, the δ-axis current iδ of the motor 7 may be regarded as being constant, and the γ-axis current compensation value iγ_lcc* may be calculated on the basis of the estimated frequency value ωest and its average value.

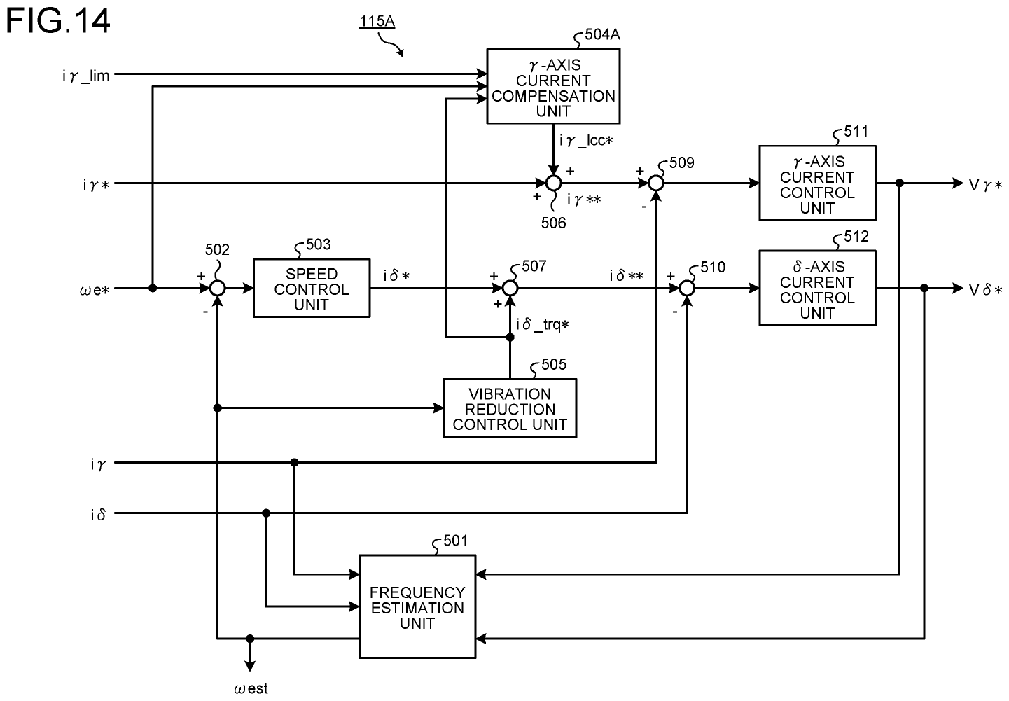

Note that the voltage command value calculation unit 115 according to the first embodiment may be configured as illustrated in FIG. 14. FIG. 14 is a block diagram illustrating an example of a configuration of a voltage command value calculation unit 115A according to a modification of the first embodiment. In FIG. 14, the γ-axis current compensation unit 504 illustrated in FIG. 8 is replaced with a γ-axis current compensation unit 504A. Also, in the configuration of FIG. 14, the input signal to the γ-axis current compensation unit 504A is changed to the δ-axis current compensation value iδ_trq* from the δ-axis current command value iδ*. The rest of the configuration is identical or equivalent to that of FIG. 8 so that components identical or equivalent to those of FIG. 8 are denoted by the same reference numerals as those in FIG. 8, and a redundant description will be omitted.

In the left graph of FIG. 12, the case where the motor power Pm is lower than the average power value Pavg is equivalent to the case where the δ-axis current compensation value iδ_trq* is negative. Thus, the γ-axis current compensation unit 504A can perform γ-axis current compensation control on the basis of the δ-axis current compensation value iδ_trq*.

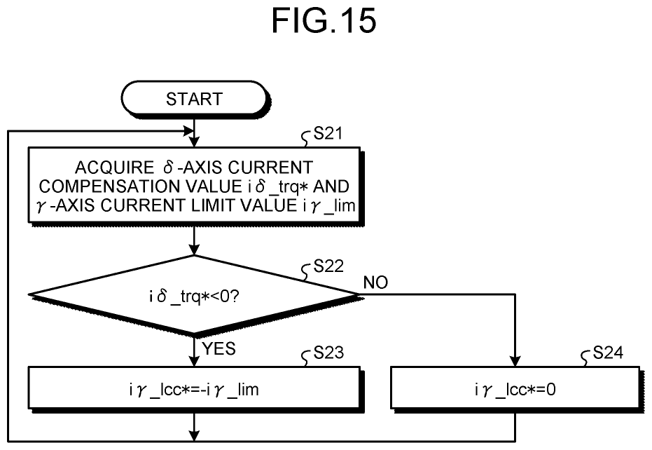

FIG. 15 is a flowchart for explaining an operation of the γ-axis current compensation unit 504A illustrated in FIG. 14.

In the controller 100, the γ-axis current compensation unit 504A acquires the õ-axis current compensation value iδ_trq* and the γ-axis current limit value iγ_lim (step S21). If the δ-axis current compensation value iδ_trq* is less than zero, that is, if the δ-axis current compensation value iδ_trq* is negative (Yes in step S22), the γ-axis current compensation unit 504A sets the γ-axis current compensation value iγ_lcc* to the γ-axis current limit value iγ_lim (step S23). However, since the direction of compensation of the γ-axis current iγ is negative, a negative sign is attached to the γ-axis current limit value iγ_lim. After that, the processing from step S21 is repeated. If the δ-axis current compensation value iδ_trq* is greater than or equal to zero, that is, if the δ-axis current compensation value iδ_trq* is not negative (No in step S22), the γ-axis current compensation unit 504A sets the γ-axis current compensation value iγ_lcc* to zero (step S24). After that, the processing from step S21 is repeated. The control according to the flowchart illustrated in FIG. 15 can also obtain the effect described above.

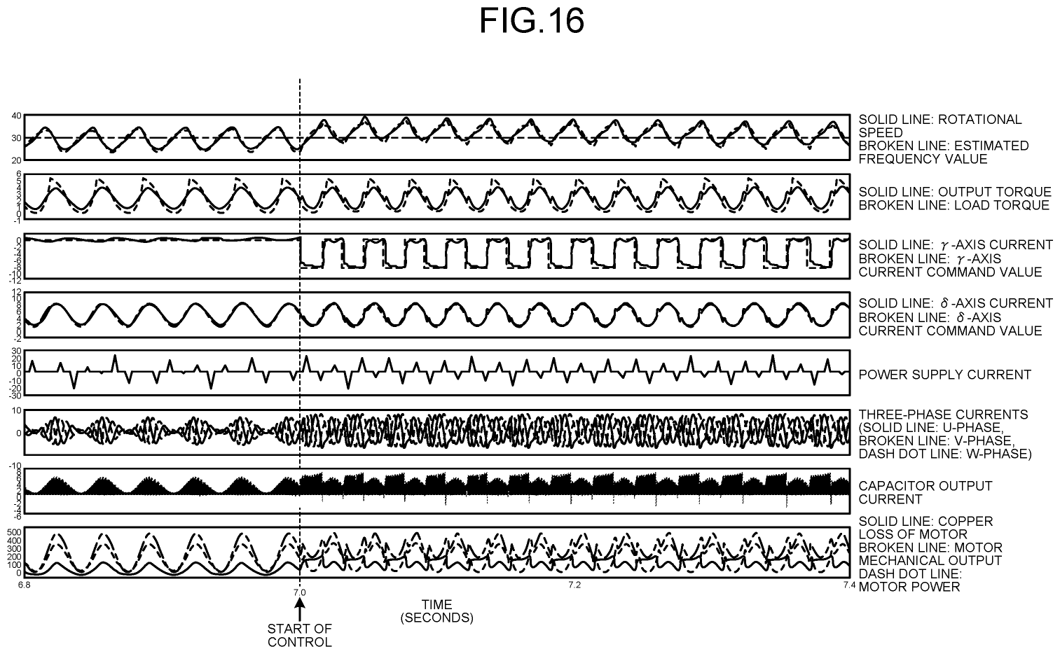

FIG. 16 is a set of graphs illustrating operation waveforms of main parts under the γ-axis current compensation control according to the first embodiment. Specifically, on the upper side of the top part of FIG. 16, the rotational speed of the motor 7 is indicated by a solid line, and the estimated frequency value ωest is indicated by a broken line. On the lower side of the top part of FIG. 16, the output torque to the motor 7 is indicated by a solid line, and the load torque is indicated by a broken line. On the upper side of the upper middle part of FIG. 16, the γ-axis current iγ is indicated by a solid line, and the γ-axis current command value iγ** is indicated by a broken line. On the lower side of the upper middle part of FIG. 16, the δ-axis current iδ is indicated by a solid line, and the δ-axis current command value iδ** is indicated by a broken line. On the upper side of the lower middle part of FIG. 16, the power supply current Iin is indicated by a solid line. On the lower side of the lower middle part of FIG. 16, of the three-phase currents of the respective phases, the U-phase current is indicated by a solid line, the V-phase current is indicated by a broken line, and the W-phase current is indicated by a dash dot line. On the upper side of the bottom part of FIG. 16, the capacitor output current idc is indicated by a solid line. On the lower side of the bottom part of FIG. 16, the copper loss of the motor 7 is indicated by a solid line, the motor mechanical output is indicated by a broken line, and the motor power Pm, that is, the sum of the copper loss and the motor mechanical output is indicated by a dash dot line. Moreover, the horizontal axis represents time, and the γ-axis current compensation control is started 7.0 seconds after the start. Note that, as also illustrated on the upper side of the upper middle part of FIG. 16, the shape of the γ-axis current compensation value iγ_lcc* is a rectangular wave.

Until the γ-axis current compensation control is started, the power supply current Iin has an imbalance between its positive and negative polarities. On the other hand, when the γ-axis current compensation control is started, it can be seen that the imbalance between the positive and negative polarities of the power supply current Iin is resolved. Note that, as illustrated on the upper side of the top part of FIG. 16, it can be seen that the range of speed variation is substantially constant before and after the start of the γ-axis current compensation control, and the vibration reduction control is active. That is, it can be seen that the vibration reduction control effectively functions without being affected by the γ-axis current compensation control.

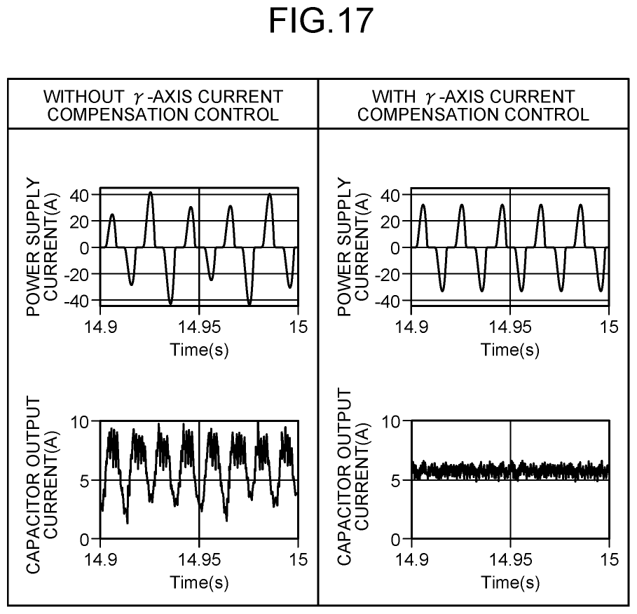

FIG. 17 is a set of graphs for explaining an effect of the γ-axis current compensation control according to the first embodiment. The left part of FIG. 17 illustrates waveforms of the power supply current and the capacitor output current when the γ-axis current compensation control is not performed. The right part of FIG. 17 illustrates waveforms of the power supply current and the capacitor output current when the γ-axis current compensation control is performed.

When the γ-axis current compensation control is not performed, as illustrated in the left part of FIG. 17, the ripple of the capacitor output current is large. Accordingly, the peak value of the power supply current fluctuates, and the harmonic components contained in the power supply current are increased as illustrated in the graph. On the other hand, when the γ-axis current compensation control is performed, as illustrated in the right part of FIG. 17, the ripple of the capacitor output current is small. Accordingly, the peak value of the power supply current is substantially constant, and the harmonic components contained in the power supply current are reduced as illustrated in the graph.

As described above, the power converter according to the first embodiment performs the first control of reducing the vibration of the load and performs the second control of reducing the ripple component of the capacitor output current that is output from the capacitor to the inverter. The second control is the control for causing a loss in the motor. This control can avoid the imbalance of the power supply current between its positive and negative polarities, and can prevent an increase in the harmonic components that can be contained in the power supply current. In addition, since the imbalance of the power supply current between the positive and negative polarities is avoided, it is easy to conform to a power supply harmonics standard. This eliminates the need to change or modify the circuit constant of the converter and the switching method of the converter, so that the motor drive apparatus that is inexpensive and highly reliable can be obtained. Moreover, due to the reduction of the power supply harmonics, the power supply power factor also increases so that an unnecessary current need not be passed. As a result, the efficiency on the converter side can be increased.

Note that the first control described above can be performed using the torque current, and the second control described above can be performed using the excitation current. Using the excitation current can reduce the width of ripple of the motor power when the second control is performed.

Moreover, the second control described above can be realized by causing a loss in the motor in the first period in which the motor power, which is the power supplied from the inverter to the motor, is lower than the set power value. The set power value may be an average value of the motor power when the first control is not performed. Also, in order to cause the loss in the motor, the absolute value of the excitation current need only be increased.

In addition, the second control described above can be realized by causing a loss in the motor in the first period in which the torque current compensation value for reducing the vibration of the load has a negative value. In order to cause the loss in the motor, the absolute value of the excitation current need only be increased. Note that the absolute value of the excitation current is preferably limited by a limit value. Limiting the absolute value of the excitation current by the limit value can secure the excitation current command value necessary for the flux weakening control while securing the torque current command value necessary for the speed control and vibration reduction control for the motor.

In addition, the value of the excitation current when the loss is generated in the motor is preferably negative. The excitation current having a negative value can keep down the possibility of the motor stepping out while preventing an increase in the harmonic components of the power supply current. Also, in the case where the motor 7 has inverse saliency, the control by which the negative excitation current flows in the negative direction coincides with the direction in which the flux weakening control is strengthened. Therefore, without forming a complicated control system, the first control of reducing the ripple of the capacitor output current and the flux weakening control can both be achieved.

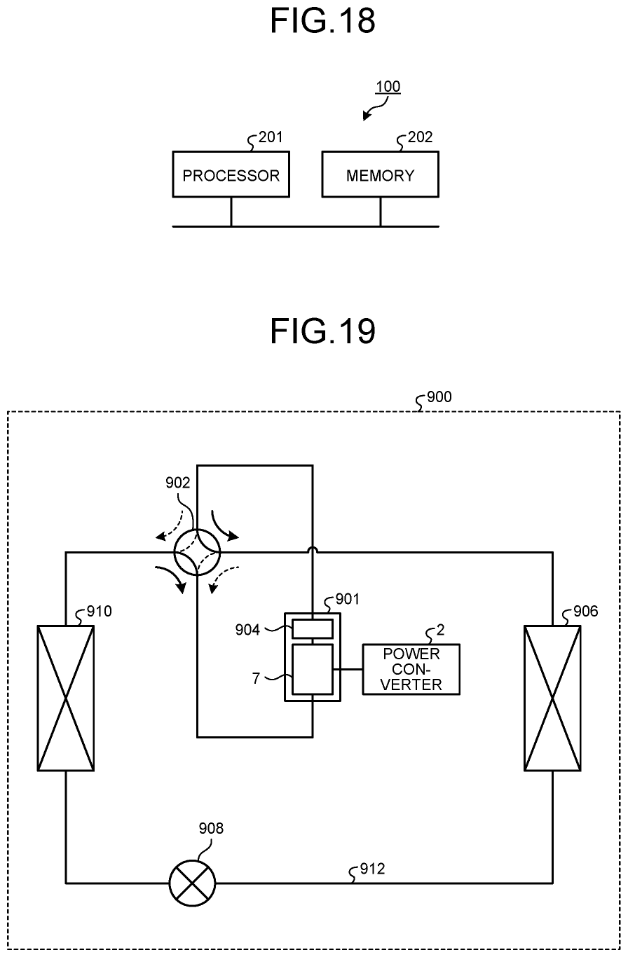

Next, a hardware configuration of the controller 100 included in the power converter 2 will be described. FIG. 18 is a diagram illustrating an example of the hardware configuration that implements the controller 100 included in the power converter 2 according to the first embodiment. The controller 100 is implemented by a processor 201 and a memory 202.

The processor 201 is a central processing unit (CPU) or a system large scale integration (LSI), the CPU being also referred to as a central processor, a processing unit, an arithmetic unit, a microprocessor, a microcomputer, a processor, or a digital signal processor (DSP). The memory 202 is, for example, a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)). The memory 202 is not limited thereto, and may be a magnetic disk, an optical disc, a compact disc, a mini disc, or a digital versatile disc (DVD).

### Second Embodiment

FIG. 19 is a diagram illustrating an example of a configuration of a refrigeration cycle applied apparatus 900 according to a second embodiment. The refrigeration cycle applied apparatus 900 according to the second embodiment includes the power converter 2 described in the first embodiment. The refrigeration cycle applied apparatus 900 according to the second embodiment can be applied to a product equipped with a refrigeration cycle such as an air conditioner, a refrigerator, a freezer, or a heat pump water heater. Note that in FIG. 19, components having functions similar to those of the first embodiment are denoted by the same reference numerals as those of the corresponding components in the first embodiment.

In the refrigeration cycle applied apparatus 900, a compressor 901 incorporating the motor 7 of the first embodiment, a four-way valve 902, an indoor heat exchanger 906, an expansion valve 908, and an outdoor heat exchanger 910 are installed via refrigerant piping 912.

Inside the compressor 901, a compression mechanism 904 that compresses a refrigerant and the motor 7 that causes the compression mechanism 904 to operate are provided.

The refrigeration cycle applied apparatus 900 can perform heating operation or cooling operation by a switching operation of the four-way valve 902. The compression mechanism 904 is driven by the motor 7 that is subject to variable speed control.

At the time of the heating operation, as indicated by solid arrows, the refrigerant is pressurized and delivered by the compression mechanism 904, passes through the four-way valve 902, the indoor heat exchanger 906, the expansion valve 908, the outdoor heat exchanger 910, and the four-way valve 902, and returns to the compression mechanism 904.

At the time of the cooling operation, as indicated by broken arrows, the refrigerant is pressurized and delivered by the compression mechanism 904, passes through the four-way valve 902, the outdoor heat exchanger 910, the expansion valve 908, the indoor heat exchanger 906, and the four-way valve 902, and returns to the compression mechanism 904.

At the time of the heating operation, the indoor heat exchanger 906 acts as a condenser to release heat, and the outdoor heat exchanger 910 acts as an evaporator to absorb heat. At the time of the cooling operation, the outdoor heat exchanger 910 acts as a condenser to release heat, and the indoor heat exchanger 906 acts as an evaporator to absorb heat. The expansion valve 908 decompresses and expands the refrigerant.

The configurations illustrated in the above embodiments each merely illustrate an example, and can thus be combined with another known technique or partially omitted and/or modified without departing from the scope of the present disclosure.

1. A power converter that supplies alternating current power to a motor that drives a load, the power converter comprising:
a converter that rectifies a power supply voltage applied from an alternating current power supply;
a capacitor connected to an output end of the converter;
an inverter connected across the capacitor; and
control circuitry that controls an operation of the inverter, wherein
the control circuitry performs first control of reducing vibration of the load and performs second control of reducing a ripple component of a capacitor output current that is output from the capacitor to the inverter, and
the second control is control of causing a loss in the motor.

2. The power converter according to claim 1, wherein
the first control is performed using a torque current, and
the second control is performed using an excitation current.

3. The power converter according to claim 2, wherein
the control circuitry controls to cause the loss in the motor in a first period in which motor power, which is power supplied from the inverter to the motor, is lower than a set power value.

4. The power converter according to claim 3, wherein
the set power value is an average value of the motor power when the second control is not performed.

5. The power converter according to claim 3, wherein
the control circuitry controls to increase an absolute value of the excitation current in the first period.

6. The power converter according to claim 2, wherein
the control circuitry controls to cause the loss in the motor in a first period in which a torque current compensation value for reducing the vibration of the load has a negative value.

7. The power converter according to claim 6, wherein
the control circuitry controls to limit an absolute value of the excitation current with a limit value when performing the second control.

8. The power converter according to claim 5, wherein
the excitation current has a negative value.

9. The power converter according to claim 1, wherein
the control circuitry includes:
command value generation circuitry that generates an excitation current command value on the basis of the torque current or the excitation current; and
current compensation circuitry that generates an excitation current compensation value for reducing the ripple component, and
the excitation current compensation value is superimposed on the excitation current command value.

10. A motor drive apparatus comprising the power converter according to claim 1.

11. A refrigeration cycle applied apparatus comprising the power converter according to claim 1.

12. The power converter according to claim 4, wherein
the control circuitry controls to increase an absolute value of the excitation current in the first period.

13. The power converter according to claim 7, wherein
the excitation current has a negative value.
